(19) United States
(12) Patent Application Publication
(10) Pub. No.: US 2024/0023544 A1
(43) Pub. Date: Jan. 25, 2024

(54) ANIMAL ATTRACTANT DISPERSAL SYSTEM

(71) Applicant: PEARCE OUTDOORS LLC, Mesa, AZ (US)

(72) Inventor: Grant Pearce, Mesa, AZ (US)

(73) Assignee: PEARCE OUTDOORS LLC, MESA, AZ (US)

(21) Appl. No.: 18/223,971

(22) Filed: Jul. 19, 2023

Related U.S. Application Data
(60) Provisional application No. 63/390,668, filed on Jul. 20, 2022.

(51) Int. Cl. A01N 25/08; A01P 19/00; A01N 37/44; A01N 65/20; A01N 65/44

(52) U.S. Cl. CPC A01N 25/08; A01P 19/00; A01N 37/44; A01N 65/20; A01N 65/44

(57) ABSTRACT

An animal attractant dispersal system, comprising a dissolvable material configured to maintain a shape in a dry environment in temperatures above zero degrees Celsius and to dissolve in a liquid and an animal attractant disposed within the dissolvable material.

### CROSS-REFERENCE TO RELATED APPLICATIONS

This application is a nonprovisional of, and claims priority to and the benefit of, U.S. Provisional Patent Application No. 63/390,668, filed Jul. 20, 2022 and entitled “ANIMAL ATTRACTANT DISPERSAL SYSTEM,” which is hereby incorporated by reference herein.

### FIELD

The present disclosure relates to the dispersal of animal attractant, and more specifically, to an attractant dispersal system comprising a dissolvable material.

### BACKGROUND

Dispersing animal attractant from a boat is a method used to attract animals of interest (e.g., fish). Large blocks of frozen material (for example ice, i.e., solid H₂O) having fish attractant therein are used by fishermen to attract fish to create areas or trails of attractant in water. However, such frozen blocks have disadvantages, such as being difficult and/or expensive to store.

### SUMMARY

This summary is provided to introduce a selection of concepts in a simplified form. These concepts are described in further detail in the detailed description of example embodiments of the disclosure below. This summary is not intended to necessarily identify key features or essential features of the claimed subject matter, nor is it intended to be used to limit the scope of the claimed subject matter.

In various embodiments, an animal attractant dispersal system is disclosed. The animal attractant dispersal system can comprise an animal attractant and a dissolvable material. The dissolvable material may be formed into a desired shape (e.g., a block) using pressure and/or heat, with the animal attractant being disposed within and held in place by the dissolvable material.

An animal attractant dispersal system can be used by contacting the system with water (e.g., by putting the system in water), causing the dissolvable material to dissolve in the water. As the dissolvable material around the animal attractant dissolves, the animal attractant can be released from the dispersal system and into the ambient environment (e.g., released into the water).

For the purpose of summarizing the disclosure and the advantages achieved over the prior art, certain objects and advantages of the disclosure have been described herein above. Of course, it is to be understood that not necessarily all such objects or advantages can be achieved in accordance with any particular embodiment or example of the disclosure. Thus, for example, those skilled in the art will recognize that the examples disclosed herein can be carried out in a manner that achieves or optimizes one advantage or group of advantages as taught or suggested herein without necessarily achieving other objects or advantages as can be taught or suggested herein.

All of these examples are intended to be within the scope of the disclosure. These and other embodiments will become readily apparent to those skilled in the art from the following detailed description of certain examples having reference to the attached FIGURES, the disclosure not being limited to any particular example(s) discussed.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing FIGURES.

FIG. 1 depicts animal attractant dispersal systems, in accordance with various examples.

### DETAILED DESCRIPTION

The detailed description of various examples herein makes reference to the accompanying drawings, which show the exemplary embodiments by way of illustration. While these exemplary embodiments are described in sufficient detail to enable those skilled in the art to practice the disclosure, it should be understood that other examples may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component or step may include a singular component or step. Also, any reference to attached, fixed, connected or the like may include permanent, removable, temporary, partial, full and/or any other possible attachment option.

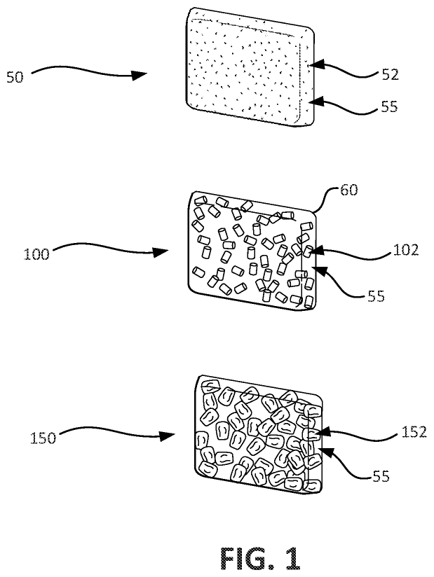

In various examples, and with reference to FIG. 1, a system (e.g., systems 50, 100, and/or 150) for dispersing an animal attractant is disclosed (e.g., a fish attractant). Such a system can comprise an animal attractant and a dissolvable (e.g., water-soluble) material. The dissolvable material (e.g., dissolvable material 55) can be configured to hold the system in a desired shape (e.g., a cube or rectangular block) and the animal attractant in position within the system in a dry environment. The dissolvable material can be configured to maintain is shape and/or state of matter (e.g., solid) in dry, non-freezing temperatures (e.g., temperatures above zero degrees Celsius). In that regard, the dissolvable material may surround and/or at least partially surround the animal attractant.

The animal attractant can comprise any suitable material. For example, an animal attractant for fish can comprise a substance configured to attract fish through olfactory, sight, taste, etc. The animal attractant may comprise any suitable form (e.g., liquid, gel, solid, powder, etc.). For example, the animal attractant can comprise a solid animal attractant (e.g., attractant 152 in system 150 dispersed within dissolvable material 55), an amino acid, a liquid or oil-based animal attractant (e.g., attractant 52 in system 50 dispersed and/or suspended and/or emulsified within dissolvable material 55), and/or any other suitable or desired animal attractant.

Solid animal attractants may comprise animal tissue derived materials and/or plant derived materials. For example, solid animal attractants may comprise ground or otherwise processed whole tissues of one or more animals and/or ground or otherwise processed whole tissues of one or more animals. The animal tissue derived materials and/or plant derived materials may be ground, without or without prior lyophilization. The animal tissue derived materials may comprise animal bones, offal, connective tissues, and/or blood. The plant derived materials may comprise plant roots, leaves, fruits, stems, grains, seeds, stalks, and other components of a plant. Solid animal attractants (e.g., for fish) can include fish meal, animal proteins (ground animal tissues, for example, ground muscle, bone, and/or connective tissue), corn, wheat (or other grains), bread, liver, krill, blood meal, shrimp meal, liver meal, and/or the like. In various examples, the solid animal attractants can also include fructose, crayfish meal, mussel (clam) meal or extract, garlic, yeast powder, spirulina, chili powder, salt, kelp meal, tiger nut flour, squid meal, bird foods, bloodworm meal, hemp seed, milk powder, peanut flour, almond flour, vanilla meal, and/or the like. Solid animal attractant can be in pellet form (e.g., attractant 102 in system 100 dispersed and/or suspended within dissolvable material 55). Solid animal attractant can in freeze dried/lyophilized form.

The animal attractant may further comprise one or more amino acids. Amino acids may include glycine, alanine, proline, arginine, taurine, valine, betaine, and/or any other suitable or desired amino acid. In various examples, the amino acids can include inosine, L-alanine, L-glutamic acid, L-arginine, glycine, leucine, isoleucine, proline, phenylalanine, tryptophan, methionine, glutamate, arginine, taurine, urea, and/or any other suitable or desired free amino acids.

Oil-based animal attractant can comprise fish oil, cod liver oil, pilchard oil, hemp oil, sunflower oil, olive oil, and/or the like. In various examples, the oil-based attractant (or liquid-based attractant) can include liquid betaine, liquid sweetener, treacle, molasses, krill oil, shrimp oil, black pepper oil, thyme oil, liquid bloodworm extract, n-butyric acid, and/or the like. As discussed further herein, oil-based animal attractant can be mixed with other animal attractant, can be in a liquid form, and can be encapsulated in a capsule or similar dissolvable system. In that regard, an oil-based animal attractant may be encapsulated within a dissolvable material capsule and embedded in the dissolvable material. In various embodiments, oil-based animal attractant may be mixed with an emulsifier to form an emulsion. In various embodiments, the emulsion may be sonicated (exposed to ultrasonic waves) to form small emulsion particles, which particles may have a diameter of between 1 microns to 1 nanometer and, in various embodiments, between 1 nanometer and 50 nanometers. Reducing emulsion particle size through sonication may assist in the dispersal of the oil-based animal attractant. The emulsion, whether or not sonicated, may then be mixed with the dissolvable material. In various embodiments, oil-based animal attractant may be mixed with a surfactant and then combines with the dissolvable material.

In various embodiments, the animal attractant can be a mix of one or more of the above-described exemplary animal attractants.

In various embodiments, the dissolvable material (e.g., dissolvable material 55) can comprise any suitable material to hold the dispersal system in a desired shape and/or form and the animal attractant in position within the system. For example, the dissolvable material can comprise a powder or particles that are compressed or coupled together via pressure and/or heat, for example, by a hydraulic press to form a compacted particulate dissolvable material. The dissolvable material within the system can comprise a sintered material. In various examples, the dissolvable material can be a material resulting from drying a solution with the animal attractant within the solution.

In various embodiments, the dissolvable material comprises a carbohydrate or group of carbohydrates. For example, various sugar compounds may be suitable for use as a dissolvable material, including sucrose, fructose, glucose, lactose as well as collections of sugar compounds including molasses, corn syrup, brown sugar, and/or solid honey (e.g., raw honey). Moreover, the dissolvable material may comprise sugar alcohols (e.g., inositol), Also for example, various complex carbohydrates may be suitable for use as a dissolvable material, including starches, rice, potato (and potato starch), gelatin, tragacanth, methylcellulose, hydroxypropylcellulose, corn, legumes, cellulose based materials, legumes, quinoa, oats, barley, chia seed, hemp seed, and other plant based sources of complex carbohydrates.

In various embodiments, the dissolvable material may act as a preservative for the animal attractant, thereby increasing shelf life. This may be achieved by blocking oxygen from reaching the animal attractant or through another interaction between the animal attractant and the dissolvable material.

In various embodiments, the dissolvable material can comprise a mineral or ionic compound (e.g., a salt such as sodium chloride, potassium chloride, and other organic and/or inorganic salts), or other suitable compound. The dissolvable material can be configured to dissolve in a liquid (e.g., water or other aqueous solution) or in response to being contacted therewith. In various embodiments, the dissolvable material is in solid form but may be dissolved or dispersed through contact with water or other aqueous solution, thereby releasing the animal attractant.

In various embodiments, the dissolvable material may be an animal attractant itself. That is, the animal attractant can be the material configured to provide the structural rigidity to maintain the desired shape of the animal attractant dispersal system, and be dissolvable in liquid (e.g., water) to gradually release the attractant in response to contact with the liquid.

In various examples, the animal attractant dispersal system may comprise a binder or binding compound. The binder may be configured to bind the other materials together to maintain the desired shape of the dispersal system (e.g., bind the dissolvable material together and/or to the animal attractant).

In accordance with various examples, the animal attractant dispersal system can be configured to be contacted with water or another liquid that dissolves the dissolvable material and releases the animal attractant therein into the surrounding environment. The animal attractant dispersal system can be configured to dissolve and/or release animal attractant at a desired rate (e.g., gradually dissolve and release attractant over thirty minutes or one or two hours). The animal attractant dispersal system, in various examples, can be any suitable size or weight (e.g., blocks weighing multiple pounds, such as five to thirty pounds).

In various examples, animal attractant dispersal system can comprise a protective coating and/or casing (e.g., casing 60) to shield the system from being exposed to liquid or moisture causing undesired dissolution of the dissolvable material (e.g., to shield from moisture in ambient air).

Benefits, other advantages, and solutions to problems have been described herein with regard to specific embodiments. Furthermore, the connecting lines shown in the various FIGURES contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various examples,” “one examples,” “an examples,” “an example embodiment,” and/or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An animal attractant dispersal system, comprising:
a dissolvable material configured to maintain a shape; and
an animal attractant disposed within the dissolvable material.

2. The animal attractant dispersal system of claim 1, wherein the dissolvable material is configured to maintain the shape in temperatures above zero degrees Celsius.

3. The animal attractant dispersal system of claim 1, wherein the dissolvable material is configured to dissolve in response to contact with a liquid.

4. The animal attractant dispersal system of claim 1, wherein the dissolvable material and the animal attractant are the same material.

5. An animal attractant dispersal system, comprising:
a dissolvable material at least partially surrounding an animal attractant disposed within the dissolvable material.

6. The animal attractant dispersal system of claim 5, wherein the dissolvable material comprises at least one of a sugar, a complex carbohydrate, and a salt.

7. The animal attractant dispersal system of claim 5, wherein the animal attractant comprises at least one of an animal tissue derived material and a plant based material.

8. The animal attractant dispersal system of claim 5, wherein the animal attractant comprises at least one of an amino acid and an oil.

9. The animal attractant dispersal system of claim 5, wherein the animal attractant comprises at least one of an amino acid and an oil.

10. The animal attractant dispersal system of claim 5, wherein the animal attractant is in pelletized form.

11. The animal attractant dispersal system of claim 5, wherein the animal attractant is in an emulsified oil-based animal attractant.

12. The animal attractant dispersal system of claim 11, wherein the emulsified oil-based animal attractant has a particle diameter of between 1 nanometer and 1 micron.

13. The animal attractant dispersal system of claim 5, wherein the animal attractant comprises an oil-based animal attractant and a surfactant.

14. The animal attractant dispersal system of claim 5, wherein the animal attractant comprises at least one of legumes, oats, and barley.

15. The animal attractant dispersal system of claim 5, the dissolvable material comprises a compacted particulate dissolvable material.

16. The animal attractant dispersal system of claim 5, further comprising a binder.
